(19) United States
(12) Patent Application Publication
(10) Pub. No.: US 2013/0103391 A1
(43) Pub. Date: Apr. 25, 2013

(54) NATURAL LANGUAGE PROCESSING FOR SOFTWARE COMMANDS

(71) Applicant: Oracle International Corporation, Redwood Shores, CA (US)

(72) Inventors: Martin Millmore, Reading (GB); Dinesh Arora, Cupertino, CA (US); Samir Buche, Isleworth (GB)

(73) Assignee: Oracle International Corporation, Redwood Shores, CA (US)

(21) Appl. No.: 13/715,776

(22) Filed: Dec. 14, 2012

Related U.S. Application Data
(63) Continuation of application No. 12/167,661, filed on Jul. 3, 2008.

(51) Int. Cl. G06F 17/27

(52) U.S. Cl. CPC G06F 17/27
USPC 704/9

(57) ABSTRACT

A system and method for facilitating user access to software functionality. An example method includes receiving natural language input; determining an identify of a user providing the input; employing the identity to facilitate selecting a software command to associate with the received natural language input; and employing software to act on the command. In a more specific embodiment, the method further includes determining an initial set of available software commands, and narrowing the initial set of available software commands based on the identity of a user and enterprise data associated with the identity of the user, resulting in a narrowed set of software commands in response thereto. Example enterprise data includes enterprise organizational chart information (e.g., corporate hierarchy information) and user access privilege information maintained by an ERP system.

### CROSS REFERENCES TO RELATED APPLICATIONS

This application is related to the following application, U.S. patent application Ser. No. 12/167,661, Publication Number U.S. 2010/0005085 A1 entitled CREATING RELATIONSHIP MAPS FROM ENTERPRISE APPLICATION SYSTEM DATA, filed on Jul. 3, 2008, which is hereby incorporated by reference, as if set forth in full in this specification.

### BACKGROUND

The present application relates to software and more specifically to user interfaces and accompanying mechanisms and methods for employing language input to control underlying software, such as Enterprise Resource Planning (ERP) software.

Natural language processing is employed in various demanding applications, including hands fee devices, mobile calendar and text messaging applications, foreign language translation software, and so on. Such applications demand user friendly mechanisms for interacting with software via language input, such as voice, and for efficiently and accurately translating language to commands.

User friendly and accurate mechanisms for interacting with software via language input are particularly important in ERP applications, which may include large suites of applications and accompanying data. Interaction with such complex systems may place increased demands on accessibility, usability, and accuracy of requirements of natural language processing mechanisms. Any inaccuracies in language translation or usability issues may inhibit enterprise productivity.

Conventionally, lack of effective mechanisms for translating spoken or typed language into software commands has inhibited more widespread use of natural language processing systems. Accordingly, existing natural language processing systems are often limited to enabling user interaction with relatively small feature sets.

However, substantially limiting user access to functions and data in an ERP system can be problematic, as users often demand use of large feature sets that often accompany ERP systems. Effective mechanisms for isolating particular functions and data from a complex set of ERP functions and data for use in natural language processing applications have been slow to develop.

### SUMMARY

An example method facilitates user access to software functionality, such as enterprise-relates software applications and accompanying actions and data. The example method includes receiving natural language input; determining an identify of a user providing the input; using the identity to facilitate processing the natural language input and associating a software command with the received natural language input; and employing software to act on the command.

In a more specific embodiment, the method further includes determining an initial set of available software commands, and narrowing the initial set of available software commands based on the identity of a user and enterprise data associated with the identity of the user, resulting in a narrowed set of software commands in response thereto. Example enterprise data includes enterprise organizational chart information (e.g., corporate hierarchy information) and user access privilege information maintained by an ERP system.

In the specific embodiment, the example method further includes using the user access privilege information to determine available data and software actions accessible to the user, and using the available data and software actions to select the software command from the narrowed set of software commands.

In an illustrative embodiment, the example method further includes parsing the natural language input into one or more nouns and one or more verbs; determining, based on the one or more nouns or the one or more verbs, a category for the natural language input; ascertaining one or more additional attributes of the natural language input; and employing the category and the one or more additional attributes to determine the software command to be associated with the natural language input.

Example categories include a query category and an action category. Example software commands include a command to retrieve data from an ERP system and a command to implement one or more other software actions. Example software actions include initiating a hiring process for enterprise personnel; retrieving location information or contact information pertaining to enterprise personnel, and so on.

The example method may further include providing various user options, including a first user option to provide the language input as voice input, and converting the voice input to text. A second user option enables accepting natural language input via an email message. A third user option includes accepting natural language input via a text message. A fourth user option includes accepting natural language input via text entered directly via a natural language processing application running on a mobile device.

Hence, certain embodiments discussed herein facilitate translating words to software-implementable actions, such as launching an ERP process or retrieving enterprise data. Use of natural language commands to facilitate interacting with ERP applications as discussed herein may enable users to quickly and efficiently access desired information and ERP system functionality from a potentially large and complex set of data and functionality.

Furthermore, employing user identity information (e.g., a user's functional access and data security permissions) and related enterprise data to filter available commands and to determine what a user intends based on a given natural language input may reduce errors and computational complexity, results in fast and accurate system responses. Hence, certain embodiments discussed herein may capitalize upon a wealth of data available in via an ERP system to improve interpretations of natural language input and to select and implement appropriate corresponding software commands.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram of a first example system that accepts natural language input to facilitate user interaction with ERP software.

FIG. 2 is a diagram illustrating a first example user interface display screen, which may be implemented via the system of FIG. 1, and which illustrates a first example user interaction involving use of voice input to retrieve enterprise data from an ERP system.

FIG. 3. is a diagram illustrating a second example user interface display screen, which illustrates a second example user interaction involving use of voice input to initiate an employee termination process.

FIG. 4 is a diagram illustrating a third example user interface display screen, which illustrates a third example user interaction involving use of direct text entry into a mobile device application.

FIG. 5 is a diagram illustrating a fourth example user interface display screen, which illustrates a fourth example user interaction involving use of email to interact with an ERP system.

FIG. 6 is a diagram illustrating a fifth example user interface display screen, which illustrates example results returned in response to a natural language query provided via the email of FIG. 5.

FIG. 7 is flow diagram of a first example process, which may be implemented via the system of FIG. 1.

FIG. 8 is a flow diagram of a second example process, which may be implemented via the system of FIG. 1.

FIG. 9 is a flow diagram of a method adapted for use with the embodiment of FIGS. 1-8.

### DETAILED DESCRIPTION OF EMBODIMENTS

For the purposes of the present discussion, an enterprise may be any organization of persons, such as a business, university, government, military, and so on. The terms “organization” and “enterprise” are employed interchangeably herein. Personnel of an organization, i.e., enterprise personnel, may include any persons associated with the organization, such as employees, contractors, board members, customer contacts, and so on.

An enterprise computing environment may be any computing environment used for a business or organization. A computing environment may be may be any collection of computing resources used to perform one or more tasks involving computer processing. An example enterprise computing environment includes various computing resources distributed across a network and may further include private and shared content on Intranet Web servers, databases, files on local hard discs or file servers, email systems, document management systems, portals, and so on.

ERP software may be any set of computer code that is adapted to facilitate managing resources of an organization. Example resources include Human Resources (HR) (e.g., enterprise personnel), financial resources, assets, employees, and so on, of an enterprise. The terms “ERP software” and “ERP application” may be employed interchangeably herein. However, an ERP application may include one or more ERP software modules or components, such as user interface software modules or components.

Enterprise software applications, such as Customer Relationship Management (CRM), Business Intelligence (BI), Enterprise Resource Planning (ERP), and project management software, often include databases with various database objects, also called data objects or entities. A database object, also called a computing object herein, may be any collection of data and/or functionality, such as data pertaining to a particular financial account, asset, employee, contact, and so on. Examples of computing objects include, but are not limited to, records, tables, nodes in tree diagrams, or other database entities corresponding to employees, customers, business resources, and so on.

Enterprise data may be any information pertaining to an organization or business, including information about projects, tasks, resources, orders, enterprise personnel and so on. Examples of enterprise data include descriptions of work orders, asset descriptions, photographs, contact information, calendar information, enterprise hierarchy information (e.g., corporate organizational chart information), and so on.

For clarity, certain well-known components, such as hard drives, processors, operating systems, power supplies, and so on, have been omitted from the figures. However, those skilled in the art with access to the present teachings will know which components to implement and how to implement them to meet the needs of a given implementation.

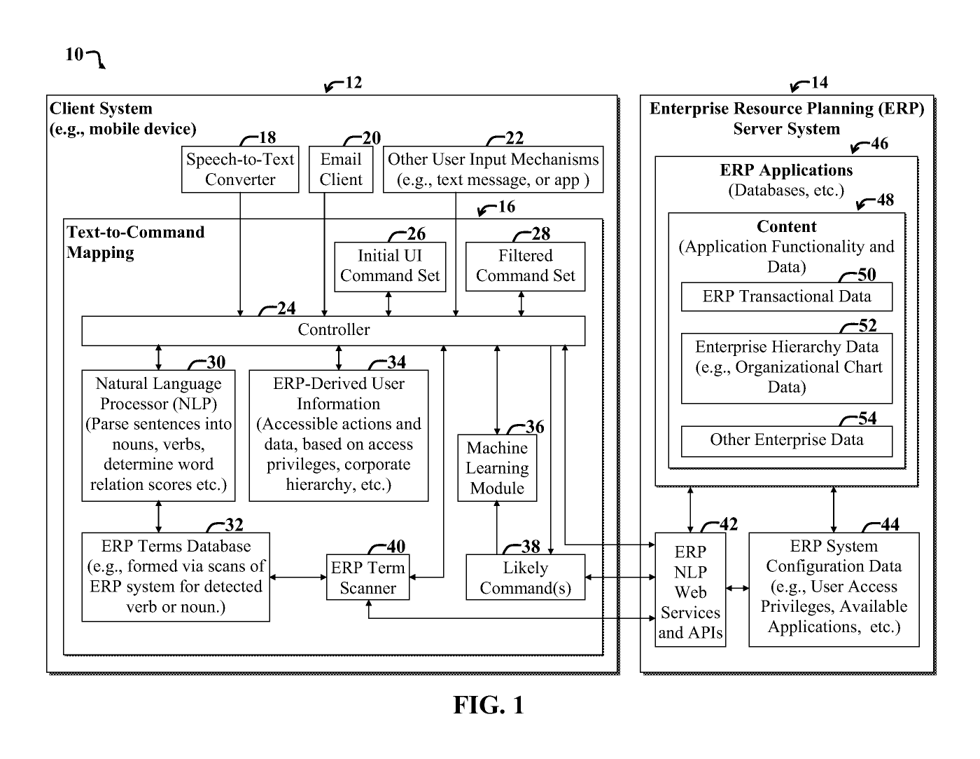

FIG. 1 is a diagram of a first example system 10 that accepts natural language input, e.g., from a speech-to-text converter 18, an email client 20, or other user input mechanisms 22, to facilitate user interaction with ERP software, such as ERP applications 46 running on an ERP server system 14. The example system 10 includes a client system 12 in communication with the ERP server system 14.

For the purposes of the present discussion, natural language input may be any instruction or information provided via spoken written (e.g., typed) human language. Examples of language input usable with certain embodiments discussed herein include voice commands, text messages (e.g., Short Message Service (SMS) text messages), emails containing text, direct text entry, and so on.

A text message may be any message that includes text and that is sent via a wireless network or other telephone network, including circuit switched and/or packet switched networks used to make telephone calls. Examples of text messages include Short Message Service (SMS) messages and MultiMedia Service (MMS) messages.

An electronic message may be any message that is adapted to be sent via a communications network. Examples of communications networks include packet-switched networks, such as the Internet, circuit-switched networks, such as the Public Switched Telephone Network (PSTN), and wireless networks, such as a Code Division Multiple Access (CDMA), Global System for Mobile communications (GSM), Analog Mobile Phone System (AMPS), Time Division Multiple Access (TDMA) or other network. Hence, a telephone call, teleconference, web conference, video conference, a text message exchange, and so on, fall within the scope of the definition of an electronic message.

An email may be a specific type of electronic message adapted to be sent via Simple Mail Transfer Protocol (SMPT), Internet Message Access Protocol (IMAP), and/or other email protocol. A chat message may be any electronic message adapted to be sent via an interface capable of indicating when another user is online or otherwise available to accept messages.

The client system 12 includes a text-to-command mapping module 16, which may receive text input from the speech-to-text converter 18, email client 20, or other user input mechanisms 22. User interface hardware and software features, such as microphones, keyboards, touch screen keypads, and so on, may be employed to provide natural language input to the modules 18-20, which may then convert the input to electronic text as needed. The resulting electronic text, representing natural language input, is input to the text-to-command mapping module 16.

For the purposes of the present discussion, electronic text may be any electronic representation of one or more letters, numbers or other characters, and may include electronic representations of natural language, such as words, sentences, and so on. The terms “electronic text” and “text” are employed interchangeably herein.

The text-to-command mapping module 16 includes a controller 24, which includes computer code for interfacing the text input modules 18-22 with various additional modules, including a Natural Language Processor (NLP) 30, a collection of ERP-derived user information 34 (e.g., identity information and related ERP data), a machine learning module, a term scanner 40, an initial User Interface (UI) command set 26, and a filtered UI command set 28, which may be included in the text-to-command mapping module 16.

The text-to-command mapping module 16 further includes an ERP terms database 32 in communication with the NLP module 30 and the ERP term scanner 40. The machine learning module 36 may communicate with the controller 24 and a memory of likely commands 38, which have been associated with text input to the text-to-command mapping module 16.

The controller 24 and term scanner 40 may communicate with the ERP server system 14 and with ERP NLP Web services and Application Programming Interfaces (APIs) 42 running on the ERP server system 14. The ERP NLP Web services and APIs 42 may include computer code for accessing a store of ERP system configuration data 44 and various ERP applications 46 maintained by the ERP server system 14. The ERP application 46 may include various databases, which may maintain content 48, including data and functionality.

For the purposes of the present discussion, software functionality may be any function, capability, or feature, e.g., stored or arranged data, that is provided via computer code, i.e., software. Generally, software functionality may be accessible via use of a user interface and accompanying user interface controls and features. Software functionality may include actions, such as retrieving data pertaining to a business object; performing an enterprise-related task, such as promoting, hiring, and firing enterprise personnel, placing orders, calculating analytics, launching certain dialog boxes, performing searches, and so on.

A software action may be any process or collection of processes implemented via software. Example processes include updating or editing data in a database, placing a product order, displaying data visualizations or analytics, triggering a sequence of processes for hiring, firing, or promoting a worker, launching an ERP software application, displaying a dialog box, and so on.

The example server-side content 48 includes ERP transactional data 50 and accompanying transactional pages, enterprise hierarchy data 52 (e.g., organizational chart information), and other enterprise data 54.

For the purposes of the present discussion, a transactional page may be any user interface window, dialog box, or other mechanism for illustrating contents of a data object and providing one or more options to manipulate the contents thereof. Transactional data may refer to any data that is grouped according to a predetermined category.

Enterprise organizational chart information may be any data pertaining to an enterprise hierarchy. A hierarchy may be any arrangement of items, e.g., objects, names, values, categories, and so on. An object or item may be any collection of or quanta of data and/or functionality. The arranged items may be ordered or positioned such that they exhibit superior or subordinate relationships with other items.

A hierarchy may refer to a displayed representation of data items or may refer to data and accompanying relationships existing irrespective of the representation. Hierarchal data may be any information characterizing a hierarchy.

In an example operative scenario, a user provides natural language input to one of the input modules 18-22, which may be implemented via a Unified Messaging System (UMS). Resulting text is then input to the controller 24. The controller 24 then employs the NLP 30 to parse the text into different portions, including nouns and verbs. The parsed nouns and verbs may be employed by the NLP 30 to determine certain attributes about the natural language input. Initial attributes may include indications as to whether the natural language input represents a request to implement a query to retrieve content; whether the input represents a request to implement another action, such as launching an ERP action or process, and so on.

The NLP may employ the ERP terms database 32 as a reference to facilitate categorizing the natural language input and determining initial attributes. The ERP terms database 32 may be populated with ERP terms in response to a scan of the ERP system 14 for terms, as implemented via the ERP term scanner 40.

Accordingly, when analyzing the text of a natural language input, an identity of a user who is providing the input, e.g., asking a question is initially determined. Subsequently, the text-to-command mapping module 16 can access and read related ERP data while processing the request.

When processing the request, when the text-to-command mapping module 16 finds a likely verb (e.g. promote, transfer, etc.), it may then access the locally stored ERP-derived user information 34 and/or connect to the ERP system 14 as needed to obtain security access data, e.g., privileges information associated with the identity and other related information.

Similarly, when the text-to-command mapping module 16 finds a likely noun, it may perform a similar process, which may further include accessing the terms database 32 and/or connecting to the ERP system 14 to find matches for the noun as needed. Matches may include synonyms.

Nouns are particularly suited for analysis based upon how strongly subjects associated with the noun are related to a logged in user, i.e., to the user's identity, as discussed more fully below. Accordingly, a wealth of information in the ERP system 14 can be used to produce a very accurate guess or estimate as to the meaning and intent behind natural language input, even when the input includes misspelled or incomplete information.

Hence, another example attribute includes a measurement of strength of association between an input noun or verb, and an ERP software action, command, data object, and so on. A strength of association may be determined by comparing an input term with terms from the ERP term database do determine a match or a degree of match and then assigning a strength value to the term based on the degree of match. Other types of associations and strengths of associations may be assigned to natural language input, as discussed more fully below.

For example, to estimate a likely question or command represented by natural language input, the text-to-command mapping module 16 may determine relationship strengths, e.g., with reference to enterprise organizational chart information, between different people in the enterprise. For example, a manager may be strongly associated with a worker that works for the manager, but weakly associated with another person with which the manager occasionally exchanges emails. Use of strength of association attributes may enhance accuracy of interpretations of natural language input.

Those skilled in the art will appreciate that exact mechanisms for determining strengths of associations are implementation specific and may vary. Those skilled in the art with access to the present teachings may readily implement methods for determining strengths of association to meet the needs of a given implementation, without undue experimentation. The NLP 30 may determine, based on the category and attributes, an initial set of guesses, i.e., candidate UI commands 26, which may be applicable to the received natural language input.

The controller 24 further includes computer code for determining the identity of a user who has provided natural language input. This code may involve analyzing an email address with reference to a list of names associated with email addresses; analyzing a phone number used to send a text message or to place a telephone call (e.g., for voice input to the speech-to-text converter 18) with reference to a list of names associated with phone numbers, and so on. Lists of names pertaining to enterprise personnel may be maintained in the ERP-derived user information data store 34. Alternatively, or in addition, a user may log into the client system 12, and the login information provided thereto may be used to establish an initial identity.

The controller 24 may then may then communicate with the ERP server system 14, e.g., via one or more ERP NLP Web services 42, and employ the initial identity information to determine ERP access privileges or permissions, security clearances, or other attributes associated with the identity, such as position in a enterprise hierarchy, such as position in an organizational chart.

For the purposes of the present discussion, an identity of a user may be any information identifying a user. For example, a user's identity may include login information, email address, phone number, name, and so on. Certain embodiments discussed herein may employ any of such identifying information to facilitate determining a mostly likely command intended by particular language input.

ERP privileges, permissions, and so on, associated with a user, may limit what enterprise software functionality, e.g., actions and data a user has access to. Similarly, enterprise hierarchy information may enable the text-to-command mapping module 16 to determine other enterprise personnel that may be closely related to the user associated with the determined identity. User access privileges to server-side ERP data and functionality may be maintained and accessible as part of the ERP system configuration data 44.

Such information, i.e., ERP privilege information and organizational chart information, represents ERP-derived information. The ERP-derived information may be collected and stored in the ERP-derived user information data store 34. The controller 24 and/or NLP module 30 may employ the additional ERP-derived user information 34 to further narrow the initial UI command set 26. A set of software commands is said to be narrowed if the set of software commands is reduced in size, e.g., by filtering, resulting in fewer software commands in the set.

For example, when the natural language input is provided by voice (e.g., via a microphone, telephone, etc.) to the speech-to-text converter 18, the speech-to-text converter 18 may sometimes make mistakes when converting voice to text. For example, the speech-to-text converter 18 might misinterpret a voiced sentence as “What is John's celery?” instead of “What is John's salary.” In this case, the text-to-command mapping module 16 can access a list of actions available to the user in the ERP system (e.g., as stored in the ERP-derived user information data store 34 and/or the ERP terms database 32) to make an intelligent guess that the question was probably “What is John's salary”. Without the ERP information, i.e., data 34, which allows the system 10 to determine what the user is allowed to do, a system might not make such informed corrections.

As another example, if a first person, e.g., a user associated with a determined identity, is closely positioned in an enterprise organizational chart relative to a second person, then an association attribute of the second person may be relatively high. Accordingly, when a name or word of natural language input is similar to a name of the second person, then the NLP 30 and controller 24 may use this association information to help estimate the intended meaning of the natural language input.

For example, if a user asks the client system 12 “What is John Smith's number?”, the text-to-command mapping module 16 can reference enterprise organizational chart information to estimate the most likely person named John Smith, e.g. someone in the user's management hierarchy.

Hence, the initial UI command set 26, which may represent a list of options that may be assigned to natural language input, may be further narrowed to reduce the size of the initial command set, resulting in the filtered command set 28. For example, John Smith for one user may be different than John Smith for another user, but the text-to-command mapping module 16 may employ the ERP-derived user information 34 to select the most likely applicable John Smith and to eliminate from consideration any less likely John Smith. Accordingly, use of the ERP-derived user information 34 as discussed herein, may enhance system accuracy in assigning or associating natural language input with ERP commands 28.

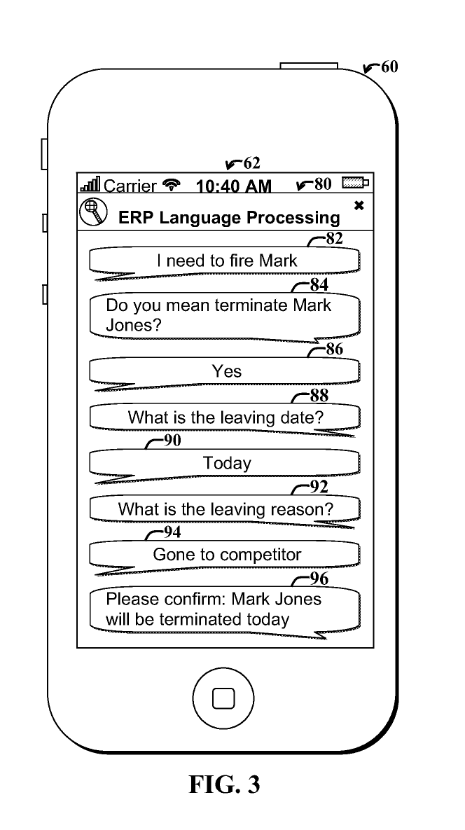

The controller 24 may determine a best guess, i.e., estimate as to what software command the user intends to have implemented in response to the input natural language, based on commands positioned in the filtered command set 28. The filtered command set 28 may have one or more candidate commands that are associated with the natural language input. When more than one command exists among the filtered commands 28, certain implementations may further filter these commands by asking additional questions to the user, e.g., via a user interface display screen, as discussed more fully below with reference to FIG. 3.

User answers to the additional questions enable the text-to-command mapping module 16 to further narrow the set of possible commands. When a command is determined with a given certainty, the resulting command 38 may be forwarded to the ERP system 14 for server-side implementation, or, depending up on the command, it may be implemented via one or more other applications running on the client system 10.

The command may involve, for example, triggering an ERP action or process, such a running a query and retrieving data, activating a server-side application to trigger display of analytics or other visualizations, initiating an employee hiring or firing process, booking a vacation, placing an order, updating records or contacts, triggering display or updating of a calendar, and so on.

The optional machine learning module 36 includes software code for storing and analyzing associations made between natural language inputs and previously determined and stored likely command(s) 38, so that when such natural language is input again in the future, that certain processing steps, such as retrieving or accessing any requisite ERP-derived user information 34, may be skipped.

Hence, the present example embodiment may enable end users to quickly access information in a way that makes sense to them. Users need not be system experts or require training Users can simply ask the system 10 to return appropriate information or to perform an action using the words that they would use if talking to another human being. The system 10 will then work within the context of a user's functional access and data security to perform an action or return data.

Note that various modules and groupings of modules shown in FIG. 1 are merely illustrative and may vary, without departing from the scope of the present teachings. For example, certain components shown running on the client system 12 may instead be implemented on a computer or collection of computers that accommodate the ERP server system 14. Furthermore, certain modules may be implemented via a single machine or may be distributed across a network.

Furthermore, various additional mechanisms for interfacing the various modules, such as the client system 12 and the ERP server system 14 may be employed. For example, in an alternative embodiment, the text-to-command mapping module 16 is implemented on the ERP server system 14 and is responsive to telephone calls made by users in the field.

In another implementation, the client system 12 represents a mobile device, such as a tablet or smartphone computing device, which may communicate with the ERP server system 14 via a wireless network and/or the Internet.

Those skilled in the art with access to the present teachings may employ readily available technologies to facilitate implementing an embodiment of the system 10. For example, Service Oriented Architectures (SOAs) involving use of Unified Messaging Services (UMSs), Business Intelligence Publishers (BIPs), accompanying Web services and APIs, and so on, may be employed to facilitate implementing embodiments discussed herein, without undue experimentation.

Furthermore, various modules may be omitted from the system 10 or combined with other modules, without departing from the scope of the present teachings. For example, in certain implementations, the controller 24 may be implemented as part of the NLP module 30; the machine learning module 36 may be omitted, and so on.

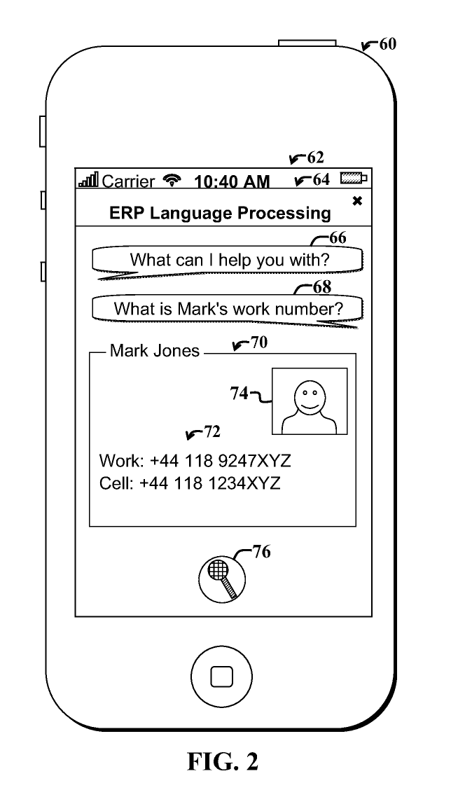

FIG. 2 is a diagram illustrating a first example user interface display screen 64, which is presented via a touch display 62 of a client system, such as a mobile device 60. The example user interface display screen 64, which may be implemented, i.e., generated via the client system 12 of FIG. 1, illustrates a first example user interaction involving use of voice input to retrieve enterprise data from an ERP system, such as the ERP system 14 of FIG. 1.

For the purposes of the present discussion, a mobile device, also called a mobile computing device, may be any computer that is adapted for portable use. A computer may be any processor coupled to memory. Examples of mobile computing devices include laptops, notebook computers, smartphones and tablets (e.g., iPhone, iPad, Galaxy Tab, Windows Mobile smartphones, Windows 7 smartphones and tablets, Android smartphones tablets, Blackberry smartphones, and so on), and so on.

The example user interface display screen 64 illustrates a first question 66 asked by mobile application used to generate the user interface display screen 64. The application asks what it can help the user with. The question may be provided via audio output and/or via text displayed in the screen 64.

The user responds by asking the application “What is Mark's work number?” in a response 68. The response 68 represents orally provided natural language input from the user, which has been translated to text for display as the response 68.

The underlying mobile application, which may correspond to the client system 12 of FIG. 1, then employs the user's identity to facilitate implementing an ERP software command to retrieve Mark's work number from the ERP system. The resulting retrieved information 70 includes Mark's phone number information 72 and may optionally include additional information, such as a picture of Mark 74.

An optional icon 76 indicates that the underlying mobile application is operating in voice mode, such that it is responsive to voice inputs. In certain implementations, the icon 76 may act as a toggle to enable a user to selectively change the mode of the application from voice mode to direct text entry mode or to another mode. Alternatively, the icon 76 may be omitted, repositioned, or only selectively displayed.

FIG. 3. is a diagram illustrating a second example user interface display screen 80, which illustrates a second example user interaction involving use of voice input to initiate an employee termination process, which represents a type of ERP process.

The user provides initial natural language input 82, stating “I need to fire Mark.” Note that the input 82 may directly follow display of the output 70 of FIG. 2, such that the interaction represented by the communications 82-92 of FIG. 3 represents a continuation of the interaction began in FIG. 2.

Since the user did not provide Mark's last name, to further refine assumptions as to what the user intends by the input 82, the application subsequently asks the user “Do you mean terminate Mark Jones?” via a first question 84. The user then confirms in a subsequent response 86.

Since the user did not specify when Mark Jones should be terminated, the application asks a second question 88, i.e., “What is the leaving date?” The user indicates “today” in a subsequent reply 90.

The underlying application is aware as to what inputs are required to implement a termination process and what inputs are not yet available. The example termination process requires not just a time at which a termination process should begin, but requires entering of reason for the termination. An example ERP termination process may involve triggering various ERP software functionality, including notifying security to escort an employee, disabling access to databases, and so on.

Accordingly, since the user did not specify why Mark Jones should be terminated, the application asks “What is the leaving reason?” in a third question 92. The user responds via another reply 94, indicating that Mark Jones has gone to a competitor.

Subsequently, the application asks for the user to confirm that Mark Jones will be terminated today, via a confirmation request 96. A subsequent user reply (not shown) may confirm or reject the termination.

The example interaction represented by the exchange of messages 82-96 is merely illustrative. Note that such an interaction may be implemented substantially server-side without use of an application running on a mobile computing device. For example, a user may employ a telephone to call into underlying software, and the software may generate voice response responses as needed and may trigger the resulting requested actions, e.g., processes, via server-side software

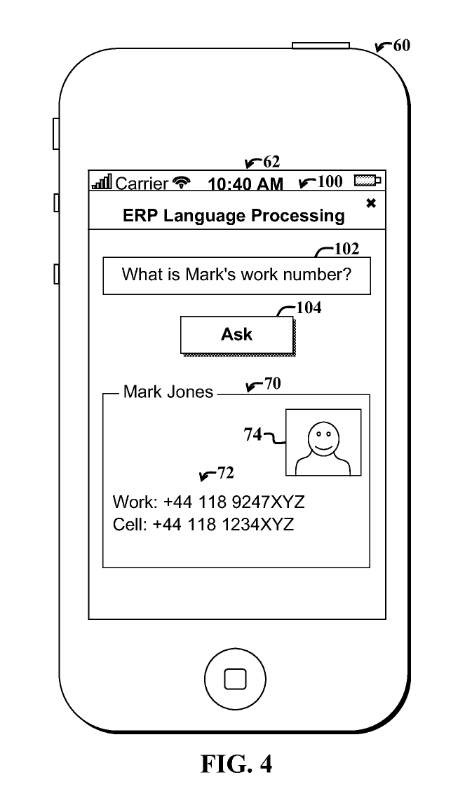

FIG. 4 is a diagram illustrating a third example user interface display screen 100, which illustrates a third example user interaction involving use of direct text entry into a mobile device application. The user interface display screen 100 and accompanying interaction is similar to that shown in FIG. 2, with the exception that the natural language input is typed directly into a field 102 of an underlying mobile application running on the mobile device 60, and an Ask button 104 is provided for triggering entry of the natural language input provided via the field 102 into the underlying application.

In the present example embodiment, the application returns results 70 in the same screen used to enter the natural language input in the text field 102. However, the results 70 may be displayed in a subsequent or different screen, without departing from the scope of the present teachings.

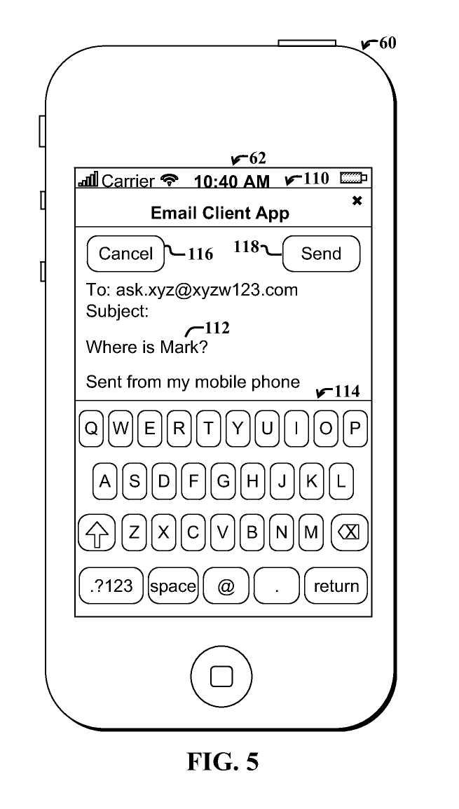

FIG. 5 is a diagram illustrating a fourth example user interface display screen 110, which illustrates a fourth example user interaction involving use of an email client to interact with an ERP system. The example user interface display screen 110 includes user interface controls 116, 118 for canceling or sending an email and an example software keypad 114 for entering text 112, i.e., natural language input.

The email message 112 is being sent to ask.xyz@xyzw123.com, which represents a hypothetical email address of an account that may be accessed by NLP software, such as the client system 12 of FIG. 1 and accompanying text-to-command mapping module 16. Accordingly, by emailing the message 112 to the indicated email address, the user effectively inputs the text 112 as natural language input to the associated NLP system.

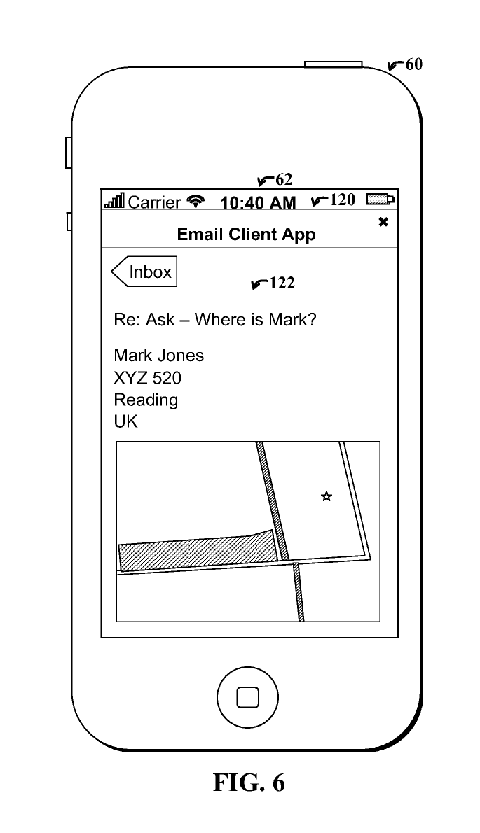

The example natural language input 112 asks “Where is Mark?” The recipient system then implements appropriate ERP action(s) and then responds to the email accordingly. An example response is shown in FIG. 6, as discussed more fully below.

FIG. 6 is a diagram illustrating a fifth example user interface display screen 120, which illustrates example results 122 returned in response to the natural language input query 112 provided via the email client interface 110 of FIG. 5. The example results 122 include an address and map showing a location associated with Mark Jones.

Various example interactions involving natural language input and resulting system responses, however, embodiment are not limited to these examples. For example, the user might ask the system “What is John's number?” The system (e.g., system 10 of FIG. 1) may then determine, with reference to the user's identity and associated ERP data, that the question may be asking for a payroll number or phone number, and multiple John's may exist within the enterprise. Accordingly, the system may respond with additional questions, or may deduce that the user intends to ask for John Smith's phone number, since the user recently communicated with John Smith via another ERP application or that John smith is a contact of the user and not an employee with a relevant payroll number.

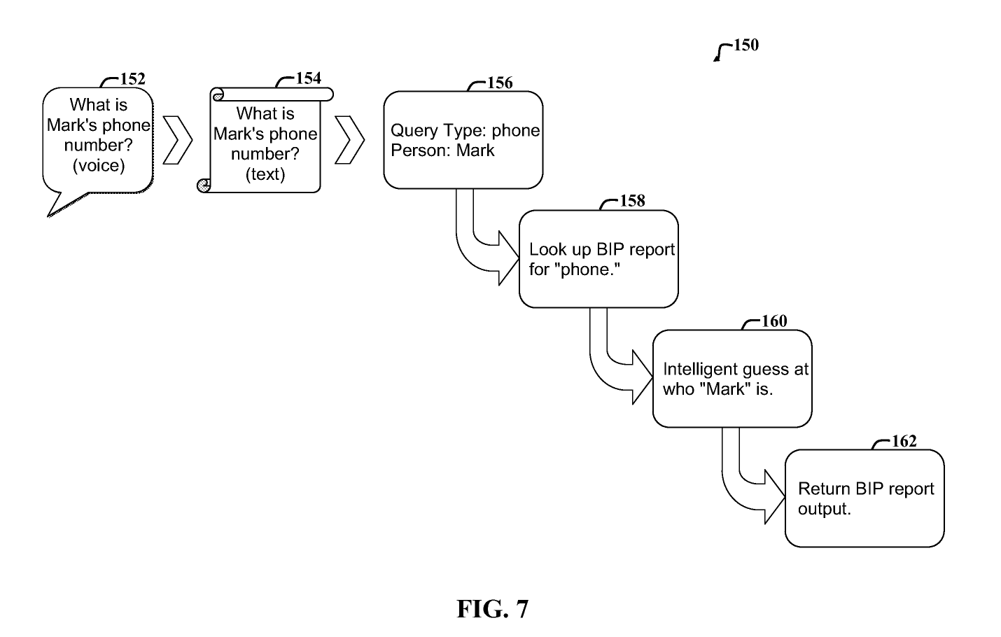

FIG. 7 is flow diagram of a first example process 150, which may be implemented via the system 10 of FIG. 1. The example process 150 includes receiving an initial voice-based question 152, which is then translated into text 154. The text is then determined to be a Query of type Phone, which is associated with a Person, with attribute Mark 156.

These determined categories and attributes 156 are then input into a Business Intelligence Publisher (BIP) program to generate a report for “Phone” 158 based upon an intelligent guess as to who “Mark” is 160, and returns a BIP report 162 accordingly.

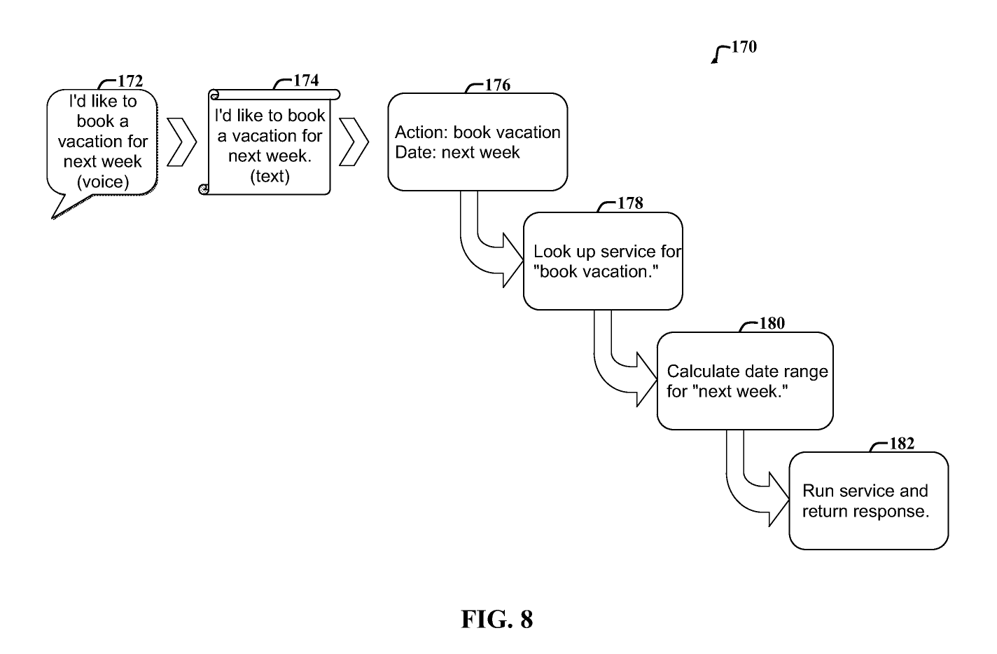

FIG. 8 is a flow diagram of a second example process 170, which may be implemented via the system 10 of FIG. 1. The example process 170 includes receiving an initial voice-based statement or request 172, which is translated to a text request 174. The text request is categorized as an “Action” of type “Book Vacation” and includes a “Date” attribute of type “Next Week” 176.

The category and attribute information 176 is then forwarded to a Web service that handles actions and processes for booking a vacation 178. The Web service then calculates the date range for “Next Week” 180 and finishes running the Web service, which returns a response 182.

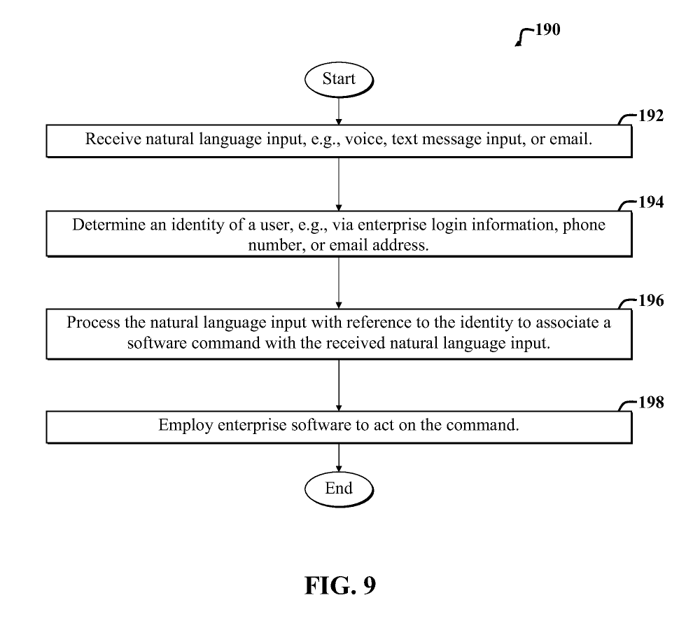

FIG. 9 is a flow diagram of a method 190 adapted for use with the embodiment of FIGS. 1-8. The example method 190 includes a first step 192, which involves receiving natural language input.

A second step 194 includes determining an identify of a user, e.g., the user's phone number, enterprise login information, email address, or other mechanism.

A third step 196 includes processing the natural language input with reference to the identity to associate a software command with the received natural language input.

The third step 196 may further involve determining an initial set of available software commands, and narrowing the initial set of available software commands based on the identity of a user and enterprise data associated with the identity of the user, resulting in a narrowed set of software commands or a selected command in response thereto.

Subsequently, a fourth step 198 includes employing the enterprise software to act on the command, i.e., to implement the command.

Note that various steps of the method 190 may be omitted, interchanged with other steps, or augmented, without departing from the scope of the present teachings. For example, the first step 192 may further include parsing the natural language input into one or more nouns and one or more verbs; determining, based on the one or more nouns or the one or more verbs, a category for the natural language input; ascertaining one or more additional attributes of the natural language input; and employing the category and the one or more additional attributes to determine the software command to be associated with the natural language input.

Additional example steps may include measuring a strength of a relationship between first object associated with a user and a second object; and determining when a portion of the natural language input may refer to the second object and selecting a software command to associate with the natural language input based on the measurement of a strength, wherein the identity of a user includes user access privilege information maintained by an Enterprise Resource Planning (ERP) system. The method may further include using the user access privilege information to determine available data and software actions accessible to the user.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for facilitating user access to software functionality, the method comprising:
receiving natural language input;
determining an identity of a user;
processing the natural language input with reference to the identity to associate a software command with the received natural language input; and
employing software to act on the command.

2. The method of claim 1, wherein the software includes enterprise software.

3. The method of claim 2, further including determining an initial set of available software commands, and narrowing the initial set of available software commands based on the identity of a user and enterprise data associated with the identity of the user, resulting in a narrowed set of software commands in response thereto.

4. The method of claim 3, wherein the enterprise data includes enterprise organizational chart information.

5. The method of claim 4, wherein the enterprise data includes a measurement of a strength of a relationship between first object associated with a user and a second object.

6. The method of claim 5, further including determining when a portion of the natural language input may refer to the second object and selecting a software command to associate with the natural language input based on the measurement of a strength.

7. The method of claim 3, wherein the identity of a user includes user access privilege information maintained by an Enterprise Resource Planning (ERP) system.

8. The method of claim 7, further including using the user access privilege information to determine available data and software actions accessible to the user.

9. The method of claim 8, further including using the available data and software actions to select the software command from the narrowed set of software commands.

10. The method of claim 1, wherein receiving further includes:
parsing the natural language input into one or more nouns and one or more verbs;
determining, based on the one or more nouns or the one or more verbs, a category for the natural language input;
ascertaining one or more attributes of the natural language input; and
employing the category and the one or more attributes to determine the software command to be associated with the natural language input.

11. The method of claim 10, wherein the category includes a query category, and wherein the software command includes a command to retrieve data from an ERP system.

12. The method of claim 10, wherein the category includes an action category, and wherein the software command includes a command to implement one or more software actions, which include triggering execution of an ERP software process.

13. The method of claim 1, wherein the software command includes a command to initiate a hiring process for enterprise personnel.

14. The method of claim 1, wherein the software command includes a command to retrieve location information pertaining to a person.

15. The method of claim 1, further including providing a first user option to provide the language input as voice input, and converting the voice input to text.

16. The method of claim 1, further including providing a second user option to provide the natural language input via an email message.

17. The method of claim 1, further including providing a third user option to provide the natural language input via a text message.

18. The method of claim 1, further including providing a fourth user option to type the natural language input into a natural language processing application running on a mobile device.

19. An apparatus comprising:
a digital processor coupled to a display and to a processor-readable storage device, wherein the processor-readable storage device includes one or more instructions executable by the digital processor to perform the following acts:
receiving natural language input;
determining an identity of a user;
processing the natural language input with reference to the identity to associate a software command with the received natural language input; and
employing software to act on the command.

20. A processor-readable storage device including instructions executable by a digital processor, the processor-readable storage device including one or more instructions for:
receiving natural language input;
determining an identity of a user;
processing the natural language input with reference to the identity to associate a software command with the received natural language input; and
employing software to act on the command.
